(19) United States
(12) Patent Application Publication
(10) Pub. No.: US 2002/0019801 A1
(43) Pub. Date: Feb. 14, 2002

(54) Network-based securities transaction system

(75) Inventor: Katsuhiro Nakade, Tokyo (JP)

Correspondence Address: David A. Blumenthal, FOLEY & LARDNER, Suite 500, 3000 K Street, N.W., Washington, DC, 20007-5109, US

(73) Assignee: NEC CORPORATION

(21) Appl. No.: 09/916,487

(22) Filed: Jul. 30, 2001

(30) Foreign Application Priority Data
Aug. 2, 2000 (JP) 234271/2000

(51) Int. Cl. G06F 17/60

(52) U.S. Cl. 705/37; 705/36

(57) ABSTRACT

A system for performing transactions of securities is composed of a customer terminal, a securities sales system, a securities transaction system, an account management system, and a network. The customer sends transaction order information and account indication information to the securities sales system. The transaction order information indicates a customer-requested transaction. The account indication information being indicates a customer account for which the customer-requested transaction is to be requested. The securities sales system transfers the transaction order information to the securities transaction system. The securities transaction system performs a transaction in response to the transaction order information, and sends transaction result information indicative of the performed transaction to the securities sales system. The securities sales system produces settlement information indicative of settlement with respect to the performed transaction in response to the transaction result information and the account indication information. The account management system settles the customer account in response to the settlement information.

### BACKGROUND OF THE INVENTION

1. Field of the Invention

The present invention relates to a network-based securities transaction technique for buying and selling securities, such as stocks, funds, and bonds. More particularly, the present invention relates to a network-based securities transaction technique for facilitating settlement of accounts for securities transaction.

2. Description of the Related Art

An on-line transaction business of securities through a network such as the Internet has been popularly carried out in recent years. FIG. 1 is a block diagram showing a conventional securities transaction system. The securities transaction system is composed of a customer terminal 110, a securities sales system 120, a securities transaction system 130, and a network 200. The customer terminal 110, the securities sales system 120, and the securities transaction system 130 are mutually connected through the network 200.

An customer accesses a securities sales home page on the network 200 provided by the securities sales system 120, through the customer terminal 110 to determine securities to buy or sell, and then place an order for a transaction through the customer terminal 110.

The securities sales system 120 receives the order and sends a transaction order information indicative of a content of the ordered transaction to the securities transaction system 130. The securities transaction system 130 performs the transaction in accordance with the sent transaction order information.

Also, international publication (WO9641293) and corresponding published Japanese translations of PCT international publication for patent application (JP-A-Heisei, 11-507150) describes a brokerage system. The brokerage system achieves the brokerage through ATM (Auto teller Machine) network.

### SUMMARY OF THE INVENTION

Therefore, an object of the present invention is to provide a securities transaction system for facilitating the settlement of accounts with respect to securities transactions.

Another object of the present invention is to provide a securities transaction system for preventing customers from carrying out an unreasonable transaction.

In order to achieve an aspect of the present invention, a system for performing transactions of securities is composed of a customer terminal, a securities sales system, a securities transaction system, an account management system, and a network. The customer terminal, the securities sales system, the securities transaction system and the account management system are connected to each other through the network. The customer terminal is programmed to show securities information concerning securities, and to send transaction order information and account indication information to the securities sales system, the transaction order information being indicative of a request for performing a customer-requested transaction from a customer, and the account indication information being indicative of a customer account for which the customer-requested transaction is to be requested. The securities sales system is programmed to provide the customer terminal with the securities information, and to transfer the transaction order information received from the customer terminal to the securities transaction system. The securities transaction system is programmed to perform a transaction in response to the transaction order information, and to send transaction result information indicative of the performed transaction to the securities sales system. The securities sales system is also programmed to produce settlement information indicative of settlement with respect to the performed transaction in response to the transaction result information and the account indication information. The account management system is programmed to settle the customer account in response to the settlement information.

The securities sales system is preferably programmed to store transaction condition information indicative of a transaction condition provided for the customer, and to transfer the transaction order information to the securities transaction system only when the customer-requested transaction fulfills the transaction condition.

The customer terminal is preferably programmed to send a customer ID for identifying the customer. In this case, the securities sales system is preferably programmed to provide the securities information in response to the customer ID.

Also, the securities sales system is programmed to provide the customer terminal in response to the customer ID with customer account information indicative of at least one available account to the customer. In this case, the customer terminal is preferably programmed to send the account indication information indicative of the at least one available account selected by the customer.

The network may be the Internet.

In order to achieve another aspect to the present invention, a method for performing transactions of securities is composed of:

providing securities information concerning securities by a customer terminal;

sending transaction order information and account indication information from the customer terminal to a securities sales system through a network, wherein the transaction order information is indicative of a request for performing a customer-requested transaction from a customer, and the account indication information is indicative of a customer account for which the customer-requested transaction is to be requested;

transferring the transaction order information from the securities sales system to a securities transaction system through the network;

performing a transaction in response to the transaction order information by the securities transaction system;

sending transaction result information indicative of the performed transaction from the securities transaction system to the securities sales system through the network;

producing settlement information indicative of settlement with respect to the performed transaction in response to the transaction result information and the account indication information by the securities sales system; and

settling the customer account in response to the settlement information.

In order to achieve still another aspect of the present invention, a securities sales system for performing transactions of securities is composed of first receiving means for receiving transaction order information and account indication information, the transaction order information being indicative of a request for performing a customer-requested transaction from a customer, and the account indication information being indicative of a customer account for which the customer-requested transaction is to be requested, transferring means for transferring the transaction order information, second receiving means for receiving transaction result information indicative of a transaction performed in response to the transaction order information, and producing means for producing settlement information indicative of settlement with respect to the performed transaction in response to the transaction result information and the account indication information.

In order to achieve yet still another aspect of the present invention, a recording medium computer-readable recording medium storing a program for a method that is composed of:

receiving transaction order information and account indication information, the transaction order information being indicative of a request for performing a customer-requested transaction from a customer, and the account indication information being indicative of a customer account for which the customer-requested transaction is to be requested,

transferring the transaction order information;

receiving transaction result information indicative of a transaction performed in response to the transaction order information;

producing settlement information indicative of settlement with respect to the performed transaction in response to the transaction result information and the account indication information.

### BRIEF DESCRIPTION OF THE DRAWINGS

FIG. 1 is a block diagram showing a conventional securities transaction system;

FIG. 2 is a block diagram showing an embodiment of a securities transaction system according to the present invention;

FIG. 3A and 3B are flowcharts showing a processing executed in the securities transaction system;

FIG. 4 shows a customer information registered in a memory 21;

FIG. 5 shows a display of securities information on the customer terminal 10;

FIG. 6 shows a display of securities information screen after an order condition is inputted; and

FIG. 7 shows an account list.

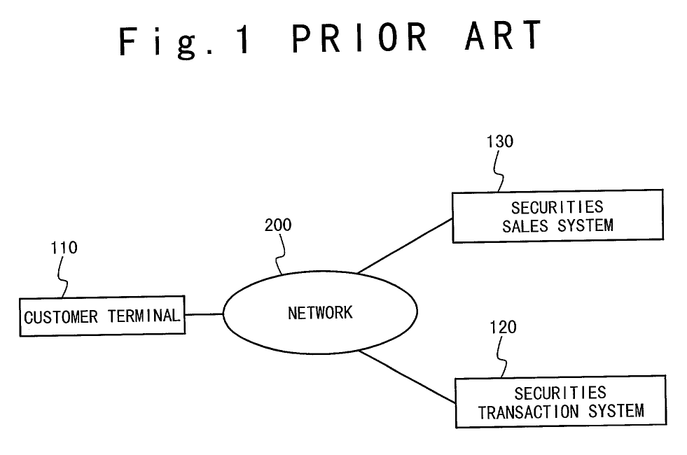

### DESCRIPTION OF THE PREFERRED EMBODIMENTS

An embodiment of the present invention will be described below with reference to the attached drawings.

### System Overview

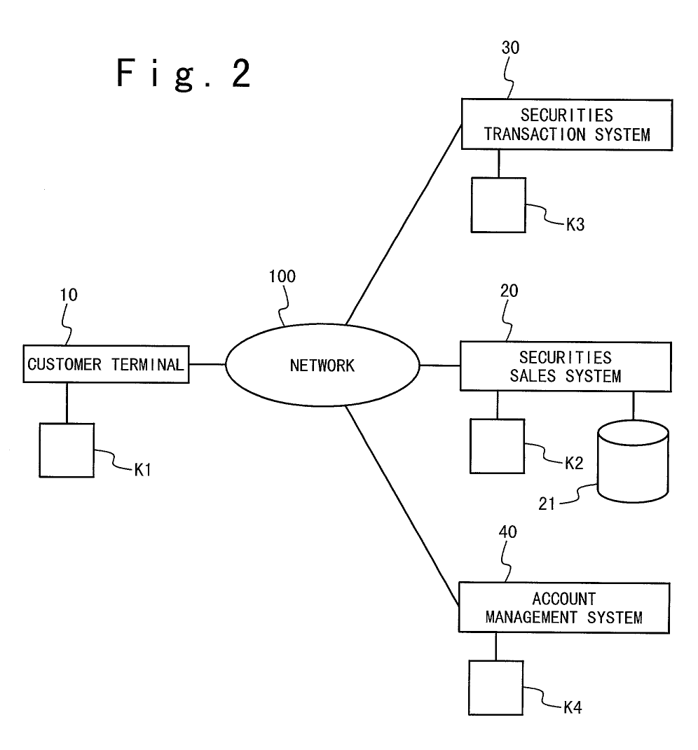

With reference to FIG. 2, an embodiment of a securities transaction system according to the present invention is provided with a customer terminal 10, a securities sales system 20, a securities transaction system 30, an account management system 40 and the Internet 100. The customer terminal 10, the securities sales system 20, the securities transaction system 30, the account management system 40 are connected to each other through the Internet 100.

The customer terminal 10 is a computer. The customer terminal 10 is programmed to access a securities information provided by the securities sales system 20, and then shows the securities information to a customer. The securities information includes information with regard to the securities such as stocks, funds, bonds, and stock index options. The customer terminal 10 is also programmed to send transaction order information and account indication information through the network 100 to the securities sales system 20. The transaction order information is indicative of a transaction requested by the customer. The account indication information is indicative of a customer account for which the transaction is to be requested. Although FIG. 2 shows only one customer terminal, a plurality of customer terminals may be connected to the network 100.

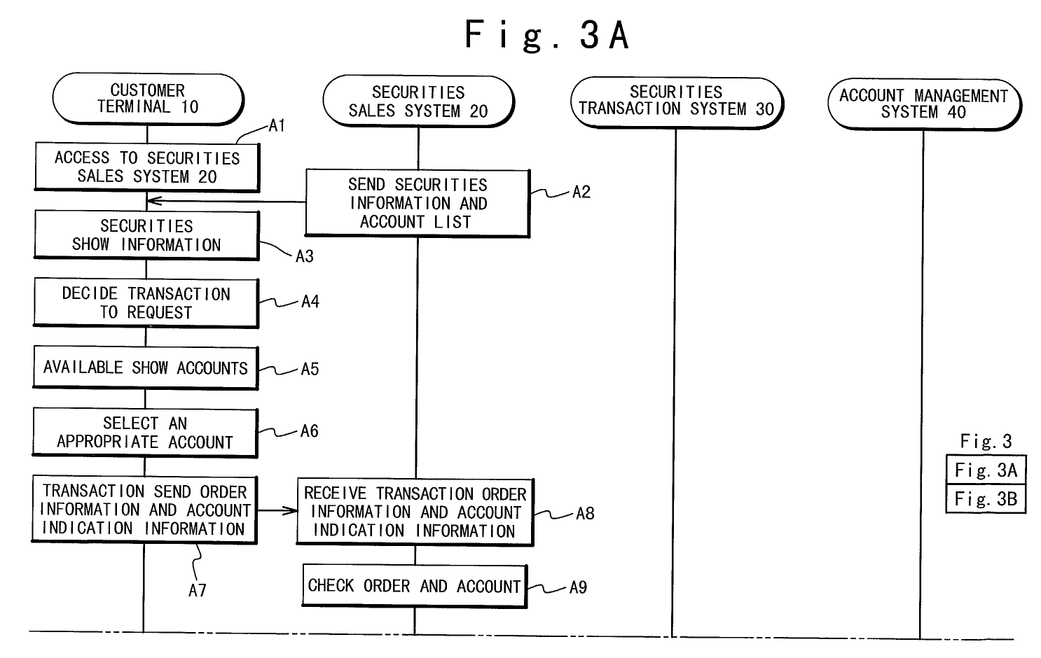

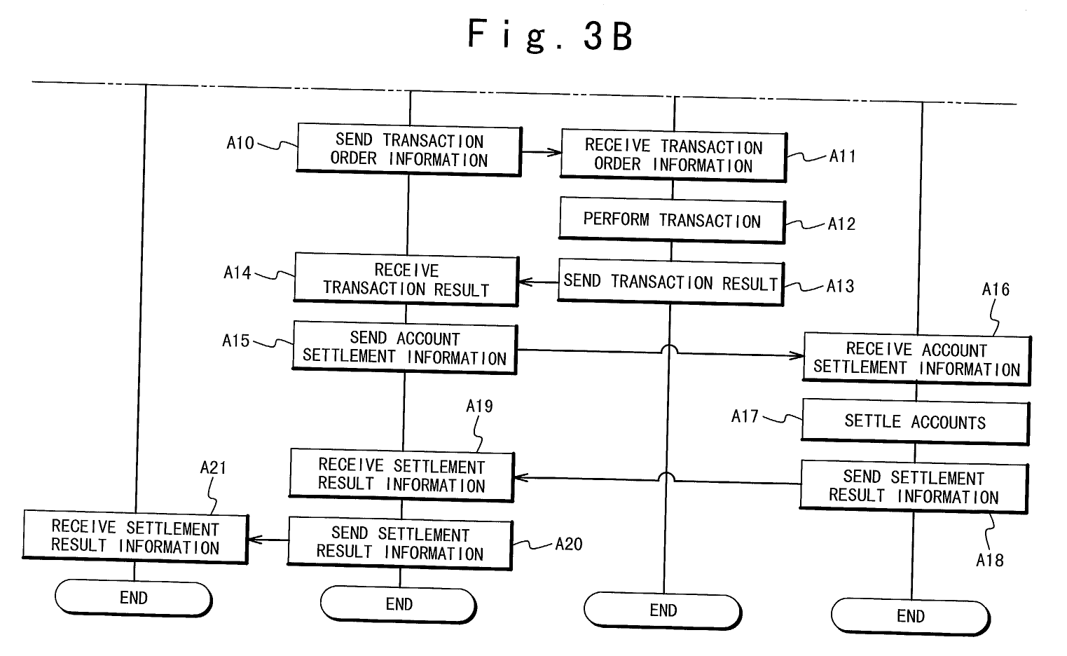

The customer terminal 10 includes a recording medium K1 such as a disc, and a semiconductor memory. The recording medium K1 records thereon a program for instructing the customer terminal 10. The program instructs the customer terminal 10 to carry out the processes at steps A1, A3 to A7, and A21 shown in FIGS. 3A and 3B.

The securities sales system 20 shown in FIG. 2 is provided for operation by a broker. The securities sales system 20 is a computer such as a workstation and a server. The securities sales system 20 is programmed to receive the account indication information and the transaction order information from the customer terminal 10. The securities sales system 20 is also programmed to check errors in the transaction order information and the account indication information, and to send the transaction order information to the securities transaction system 30 if no error is found. Moreover, the securities sales system 20 is programmed to receive a transaction result from the securities transaction system 30, and sending account settlement information to the account management system 40 in response to the received transaction result indicating a content of the performed transaction. Although FIG. 2 shows only one securities sales system 20, a plurality of securities sales systems 20 may be connected to the network 100.

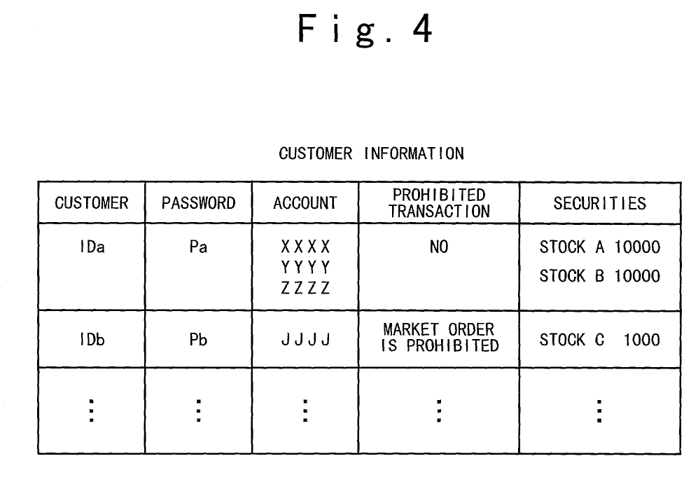

The securities sales system 20 includes a memory 21 which resisters therein a customer information shown in FIG. 4. The customer information contains a customer ID for each customer, a password, an account for which a transaction is to be requested, a condition(s) on which a transaction is permitted, and information indicative of securities held by each customer. In FIG. 4, a customer of a customer ID [IDa] has a password [Pa], three customer accounts [XXXX], [YYYY] and [ZZZZ] for settlement, and has [No-Limitation] on a transaction, and holds securities of [10000 Shares of Stock A] and [10000 Shares of Stock B]. Also, an customer of an customer ID [IDb] has a password [Pb], a customer account [JJJJ] for settlement, and has a [Market Order Prohibition] option with regard to a transaction, and holds securities of [1000 Shares of Stock C]. The customer of a customer ID [IDb] is prohibited from performing any market orders based on the customer information.

The securities sales system 20 includes a recording medium K2 such as a disc, and a semiconductor memory. The recording medium K2 records thereon a program for instructing the securities sales system 20. The program instructs the securities sales system 20 to carry out the processes at steps A2, A8 to A10, A14, A15, A19 and A20 of FIGS. 3A and 3B.

The securities transaction system 30 shown in FIG. 2 is provided for a securities market. The securities transaction system 30 is programmed to receive the transaction order information from the securities sales system 20, and to perform a transaction in response to the transaction order information, and to send the transaction result information indicative of the performed transaction to the securities sales system 20.

The securities transaction system 30 includes a recording medium K3 such as a disc, and a semiconductor memory. The recording medium K3 records thereon a program for instructing the securities transaction system 30 to carry out the processes at steps All to A13 shown in FIGS. 3A and 3B.

The account management system 40 is managed by a bank. The account management system 40 is a computer such as a workstation and a server. The account management system 40 is programmed to receive account settlement information from the securities sales system 20, and to settle accounts with respect to the performed transactions in response to the account settlement information. When the performed transaction is buying stocks, the account management system 40 transfers the payment from the customer account to an account of the broker operating the securities sales system 20. When the performed transaction is selling stocks, the account management system 40 transfers the payment from the broker's account to the customer account.

The account management system 40 includes a recording medium K4 such as a disc and a semiconductor memory. The recording medium K4 records thereon a program for instructing the account management system 40 to carry out the processes at steps A16 to A18 of FIG. 3B.

### Operation of the Securities Transaction System

The operations of this embodiment will be described below in detail.

With reference to FIG. 3A, a customer accesses a securities sale home page provided by a securities sales system 20 through the customer terminal 10 (Step A1). The customer sends a customer ID and a password to the securities sales system 20.

The securities sales system 20 receives the customer ID and the password from the customer terminal 10. Then the securities sales system 20 collates the received password with a password corresponding to the customer ID registered in the memory 21. If the received and registered passwords coincide with each other, the securities sales system 20 sends securities information (containing stock codes and names of stocks) to the customer terminal 10. The securities sales system 20 also sends an account list showing an account(s) available to the customer to the customer terminal 10 (Step A2). The available account(s) are registered in the memory 21 corresponding to the customer ID. If the received and registered passwords do not coincide with each other, the securities sales system 20 requires the customer terminal 10 to send a password again.

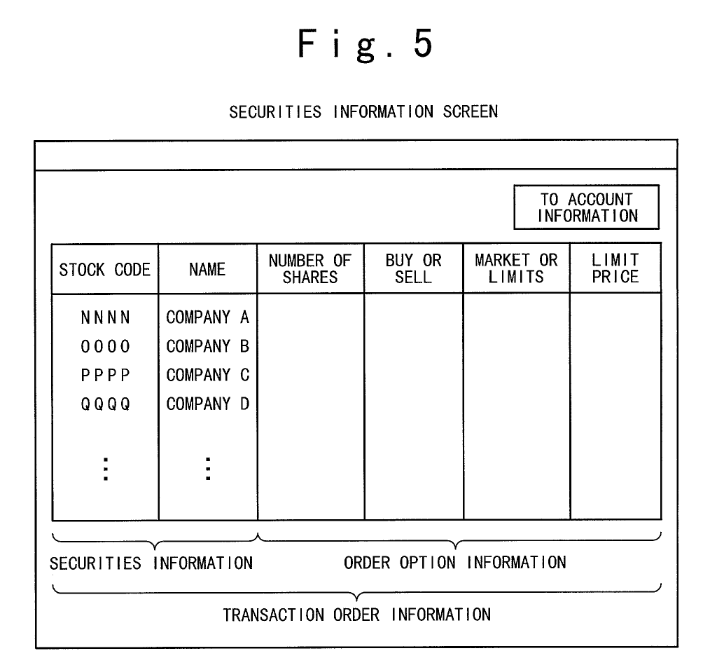

Then, the customer terminal 10 displays a securities information screen (Step A3). FIG. 5 shows the securities information screen. In the securities information screen, the securities information and an input column for inputting order option information are also displayed. The order option information includes the number of buying or selling stocks, a transaction option indicating whether the requested transaction is buying or selling, an order option indicating whether the requested transaction is a market order or a limit order, and a limit price for the limit order.

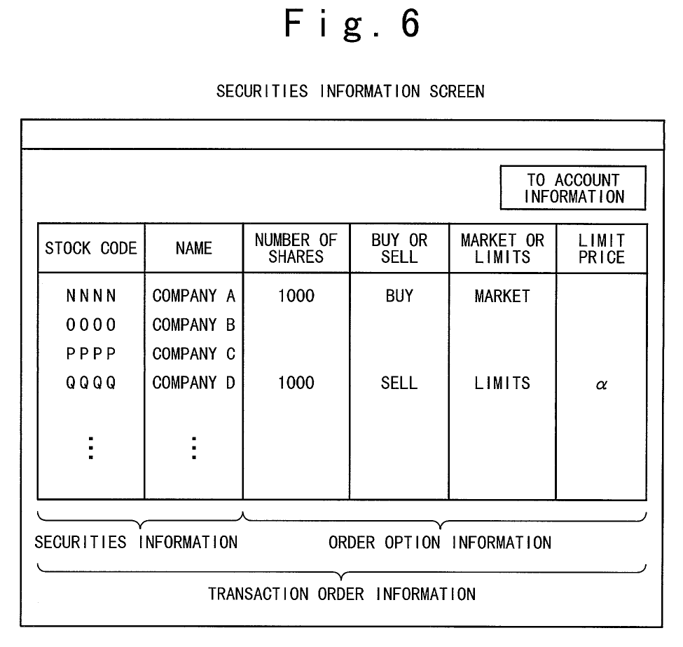

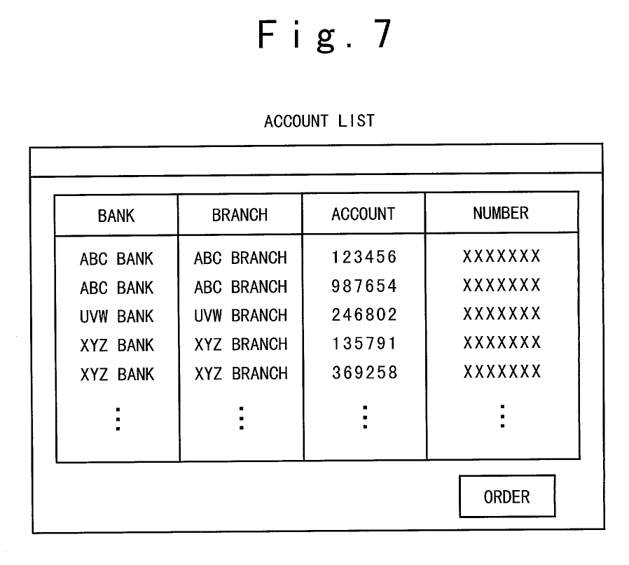

Then, the customer decides a transaction to request and enters a content of the requested transaction in lines of an order condition information input column as shown in FIG. 3A (Step A4). Here, let us suppose that the customer decides to buy 1000 shares of the stock of Company A at a market price, and to sell 1000 shares of the stock of Company D at the limit price. As shown in FIG. 6, the customer enters the number of shares [1000], a transaction option [Buy] and an order option [Market Order] in the first line corresponding to Company A. The customer also enters the number of shares [1000], a transaction option [Selling], an order option [Limit] and a limit price [α] in the fourth line, which corresponds to the D corporation. The customer terminal 10 transiently stores the pairs of the order option information and the securities information as the transaction order information. As for the example shown in FIG. 6, the customer terminal 10 transiently stores first and second transaction order information, the first transaction order information being indicative of a stock code [NNNN], the name [Company A], the number of shares [1000], the transaction option [Buy] and the order option [Market Order], and the second transaction order information being indicative of a stock code [QQQQ], the name [Company D], the number of shares [1000], the transaction option [Selling], the order option [Limit], and the limit price [α] Then, the customer clicks a [To Account Information] button on the securities information screen, and the customer terminal 10 displays an account list screen shown in FIG. 7. The list of the available accounts received from the securities sales system 20 is shown in the account list screen. The shown list includes information of bank names, branch names, account numbers, the holder names of the accounts. The customer consults the list and selects one of the available account(s) for which the requested transaction is to be requested (Step A6). The information indicative of the selected account is transiently held by the customer terminal 10 as the account indication information.

When the customer clicks an [Order] button provided on the account list screen, the customer terminal 10 sends the account indication information and the transaction order information through the Internet 100 to the securities sales system 20 as shown in FIG. 3A (Step A7). A first set of the first transaction order information and the account indication information and a second set of the second transaction order information and the account indication information are sent to the securities sales system 20.

The securities sales system 20 receives the sets of the transaction order information and the account indication information (Step A8). The securities sales system 20 checks the transaction order information and the account indication information as described in the following.

(a) At first, the securities sales system 20 checks whether or not the customer account indicated by the account indication information coincides with any of the available accounts informed to the customer terminal 10 at the step A2. Then, if the customer account does not coincide with any of the available accounts, an error report is sent to the customer terminal 10.

(b) If so, the securities sales system 20 checks whether or not the order option information in the transaction order information satisfies or fulfills all the conditions registered in the memory 21 for the customer. For example, the securities sales system 20 checks whether or not the order option is the market order while the market order is inhibited, or whether or not the number of shares exceeds the permitted maximum number. If the order option information does not satisfy at least one of the conditions, the error report is sent to the customer terminal 10.

(c) Then, If the transaction option in the order condition information is [Selling], the securities sales system 20 checks whether or not the customer has the securities to be sold, consulting the customer information registered in the memory 21. If the customer does not have the securities to be sold, an error report is sent to the customer terminal 10.

Then, as shown in FIG. 3B, the securities sales system 20 sends to the securities transaction system 30 the transaction order information with a system identifier for identifying the sending securities sales system 20, and a transaction order identifier for identifying the transaction order information (Step A10). The transaction order identifier may be a series number. At Step 10, in addition, the securities sales system 20 registers therein the set of the account indication information and the transaction order information, the customer ID of the customer, and the transaction order identifier, correlating them each other.

The securities transaction system 30 receives the set of transaction order information, a system identifier and a transaction order identifier (Step A11). The securities transaction system 30 performs the requested transaction based on the transaction order information (Step A12). After that, the securities transaction system 30 sends a pair of the transaction order identifier and the transaction result information indicative of the performed transaction to the securities sales system 20 represented by the system identifier (Step A13). The transaction result information includes information indicating whether or not the transaction is established, information indicating whether the established transaction is buying or selling if the transaction is established, and the payment.

The securities sales system 20 receives the pair of the transaction result information and the transaction order identifier from the securities transaction system 30 (Step A14), and investigates whether or not the transaction is established. If the transaction is not established, the securities sales system 20 reports a failure of the transaction to the customer terminal 10. The transaction order identifier corresponding to the transaction order information is also reported to the customer terminal 10 for inform the customer of which part of the transaction is not established. Also, securities sales system 20 removes the information related to the transaction order identifier.

If the transaction is established, the securities sales system 20 prepares an account settlement information indicative of the settlement of accounts. For the settlement, the customer account indicated by the account indication information is used. The securities sales system 20 sends the account settlement information to the account management system 40 (Step A15). The account settlement information is prepared as follows. At first, the securities sales system 20 extracts the account indication information and the customer ID correlated with the transaction order identifier received from the securities transaction system 30. Next, the securities sales system 20 extracts information indicating the payment to be settled, and the transaction option from the transaction result information, which is received at the step A14. When the securities sales system 20 recognized that the transaction option is “selling”, the account settlement information is prepared so as to transfer the extracted payment from the broker's account to the customer account specified by the account indication information. On the contrary, When the securities sales system 20 recognized that the transaction option is “buying”, the account settlement information is prepared so as to transfer the extracted payment from the customer account to the broker's account. Also, the information indicative of the securities owned by the customer of the customer information (refer to FIG. 4) is updated on the basis of the transaction result information.

The account management system 40 receives the account settlement information (Step 16). Then the account management system 40 checks whether or not the customer account indicated by the account settlement information coincides with one of the accounts previously registered therein. When the customer account coincides with the one account, a transfer is carried out between the customer account and the broker's account to settle the accounts (Step 17). The account management system 40 sends settlement result information indicative of the result of the settlement to the securities sales system 20 (Step 18).

The securities sales system 20 receives the settlement result information from the account management system 40 and transfers it to the customer terminal 10 (Steps A19, A20).

The customer terminal 10 receives the settlement result information from the securities sales system 20, and displays it to the customer (Step A21).

Here, the securities sales system 20 may electronically inform the customer of the information with regard to the check results of the transaction order information and the account indication information, the transaction result information sent from the securities transaction system 30 and the settlement result from the account management system 40. The informing may be achieved through a home page provided by the securities sales system 20, or electronic mails.

Although the invention has been described in its preferred form with a certain degree of particularity, it is understood that the present disclosure of the preferred form has been changed in the details of construction and the combination and arrangement of parts may be resorted to without departing from the spirit and the scope of the invention as hereinafter claimed.

What is claimed is:

1. A system for performing transactions of securities comprising:
a customer terminal;
a securities sales system;
a securities transaction system;
an account management system, and
a network through which said customer terminal, said securities sales system, said securities transaction system and said account management system are connected to each other, wherein
said customer terminal is programmed to show securities information concerning securities, and to send transaction order information and account indication information to said securities sales system, said transaction order information being indicative of a request for performing a customer-requested transaction from a customer, and said account indication information being indicative of a customer account for which said customer-requested transaction is to be requested, and
said securities sales system is programmed to provide said customer terminal with said securities information, and to transfer said transaction order information received from said customer terminal to said securities transaction system, and
said securities transaction system is programmed to perform a transaction in response to said transaction order information, and to send transaction result information indicative of said performed transaction to said securities sales system, said securities sales system being programmed to produce settlement information indicative of settlement with respect to said performed transaction in response to said transaction result information and said account indication information, and
said account management system is programmed to settle said customer account in response to said settlement information.

2. The system according to claim 1, wherein securities sales system is programmed to store transaction condition information indicative of a transaction condition provided for said customer, and to transfer said transaction order information to said securities transaction system only when said customer-requested transaction fulfills said transaction condition.

3. The system according to claim 1, wherein said customer terminal is programmed to send a customer ID for identifying said customer, and said securities sales system is programmed to provide said securities information in response to said customer ID.

4. The system according to claim 1, wherein said customer terminal is programmed to send a customer ID,
and said securities sales system is programmed to provide said customer terminal in response to said customer ID with customer account information indicative of at least one available account to said customer, said customer terminal being programmed to send said account indication information indicative of said at least one available account selected by said customer.

5. The system according to claim 1, wherein said network is the Internet.

6. A method for performing transactions of securities comprising:
providing securities information concerning securities by a customer terminal;
sending transaction order information and account indication information from said customer terminal to a securities sales system through a network, wherein said transaction order information is indicative of a request for performing a customer-requested transaction from a customer, and said account indication information is indicative of a customer account for which said customer-requested transaction is to be requested;
transferring said transaction order information from said securities sales system to a securities transaction system through said network;
performing a transaction in response to said transaction order information by said securities transaction system;
sending transaction result information indicative of said performed transaction from said securities transaction system to said securities sales system through said network;
producing settlement information indicative of settlement with respect to said performed transaction in response to said transaction result information and said account indication information by said securities sales system; and
settling said customer account in response to said settlement information.

7. The method according to claim 6, further comprising:
storing transaction condition information indicative of a transaction condition provided for said customer to said securities sales system, wherein
said transferring is executed only when said customer-requested transaction fulfills said transaction condition.

8. The method according to claim 6, further comprising:
sending a customer ID for identifying said customer from said customer terminal to said securities sales system in response to input to said customer terminal; and
sending said securities information from said customer terminal to said securities sales system in response to said customer ID.

9. The method according to claim 6, further comprising:
sending a customer ID for identifying said customer from said customer terminal to said securities sales system in response to input to said customer terminal; and
providing said customer terminal in response to said customer ID with customer account information indicative of at least one available account to said customer,
sending said account indication information in response to selection by said customer.

10. The method according to claim 6, wherein said network is the Internet.

11. A securities sales system for performing transactions of securities comprising:
first receiving means for receiving transaction order information and account indication information, wherein said transaction order information is indicative of a request for performing a customer-requested transaction from a customer, and said account indication information is indicative of a customer account for which said customer-requested transaction is to be requested,
transferring means for transferring said transaction order information;
second receiving means for receiving transaction result information indicative of a transaction performed in response to said transaction order information;
producing means for producing settlement information indicative of settlement with respect to said performed transaction in response to said transaction result information and said account indication information.

12. The securities sales system according to claim 11, wherein said transaction order information is transferred only when said customer-requested transaction fulfills said transaction condition.

13. A recording medium computer-readable recording medium storing a program for a method which comprises:
receiving transaction order information and account indication information, wherein said transaction order information is indicative of a request for performing a customer-requested transaction from a customer, and said account indication information is indicative of a customer account for which said customer-requested transaction is to be requested,
transferring said transaction order information;
receiving transaction result information indicative of a transaction performed in response to said transaction order information;
producing settlement information indicative of settlement with respect to said performed transaction in response to said transaction result information and said account indication information.
